(19) United States
(12) Patent Application Publication
(10) Pub. No.: US 2012/0326007 A1
(43) Pub. Date: Dec. 27, 2012

(54) OBJECT DETECTING DEVICE AND INFORMATION ACQUIRING DEVICE

(75) Inventor: Hiroyuki MUTO, Nagoya-shi (JP)

(73) Assignee: Sanyo Electric Co., Ltd., Moriguchi-shi (JP)

(21) Appl. No.: 13/599,904

(22) Filed: Aug. 30, 2012

Related U.S. Application Data
(63) Continuation of application No. PCT/JP2011/075384, filed on Nov. 4, 2011.

(30) Foreign Application Priority Data
Mar. 3, 2011 (JP) 2011-046852
May 25, 2011 (JP) 2011-116704

(51) Int. Cl. G01C 3/24

(52) U.S. Cl. 250/206.2

(57) ABSTRACT

An information acquiring device has a light source which emits light of a predetermined wavelength band; a light receiving element which receives reflected light reflected on the target area for outputting a signal; an information acquiring section which searches a corresponding area corresponding to the segment area from an actual measurement pattern of the light received by the light receiving element; and a spreading detecting section which detects a change in a degree of spreading of a light receiving area of the actual measurement pattern. The information acquiring section performs a searching operation of the corresponding area along a searching line in parallel to an alignment direction in which the light source and the light receiving element are aligned, and displaces the searching line with respect to each segment area in a direction perpendicular to the alignment direction in accordance with the change in the degree of spreading.

This application claims priority under 35 U.S.C. Section 119 of Japanese Patent Application No. 2011-046852 filed Mar. 3, 2011, entitled “OBJECT DETECTING DEVICE AND INFORMATION ACQUIRING DEVICE” and Japanese Patent Application No. 2011-116704 filed May 25, 2011, entitled “OBJECT DETECTING DEVICE AND INFORMATION ACQUIRING DEVICE”. The disclosures of the above applications are incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to scan a target area with laser light having a predetermined dot pattern is operable to receive a dot pattern reflected on the target area on an image sensor for detecting a distance to each portion of an object to be detected, based on a light receiving position of the dot pattern on the image sensor, using a triangulation method (see e.g. pp. 1279-1280, the 19th Annual Conference Proceedings (Sep. 18-20, 2001) by the Robotics Society of Japan).

In the above method, for instance, laser light having a dot pattern is emitted in a state that a reflection plane is disposed at a position away from an irradiation portion of laser light by a certain distance, and the dot pattern of laser light irradiated onto the image sensor is retained as a template. Then, a matching operation is performed between a dot pattern of laser light irradiated onto the image sensor at the time of actual measurement, and the dot pattern retained in the template for detecting to which position on the dot pattern at the time of actual measurement, a segment area set on the dot pattern of the template has moved. The distance to each portion, in the target area, corresponding to each segment area, is calculated, based on the moving amount.

In the object detecting device thus constructed, a diffractive optical element for generating laser light having a dot pattern is used. The optical characteristic of the diffractive optical element depends on the wavelength of laser light. On the other hand, the wavelength of laser light is likely to change depending on e.g. a temperature change of a light source. In view of the above, if the wavelength of laser light changes depending on e.g. a temperature change, the dot pattern of laser light also changes, as the wavelength of laser light changes. If the dot pattern changes as described above, it is impossible to accurately perform a matching operation between a dot pattern at the time of actual measurement, and the dot pattern retained in the template. As a result, detection precision of a distance to an object to be detected may be lowered.

In view of the above, an arrangement of adjusting the temperature of the laser light source may be provided to retain the wavelength of laser light unchanged. The above arrangement, however, requires an element such as a Peltier element for temperature adjustment, and may increase the cost.

### SUMMARY OF THE INVENTION

A first aspect of the invention is directed to an information acquiring device for acquiring information on a target area using light. The information acquiring device according to the first aspect includes a light source which emits light of a predetermined wavelength band; a diffractive optical element which irradiates the light onto the target area with a predetermined dot pattern; a light receiving element which receives reflected light reflected on the target area for outputting a signal; a storage which stores a reference template in which a plurality of segment areas is set in a reference pattern of the light received by the light receiving element; an information acquiring section which searches a corresponding area corresponding to the segment area from an actual measurement pattern of the light received by the light receiving element for acquiring three-dimensional information of an object in the target area, based on a position of the searched corresponding area; and a spreading detecting section which detects a change in a degree of spreading of a light receiving area of the actual measurement pattern with respect to a setting area of the reference pattern. The information acquiring section performs a searching operation of the corresponding area with respect to the actual measurement pattern along a searching line in parallel to an alignment direction in which the light source and the light receiving element are aligned, and displaces the searching line with respect to each segment area in a direction perpendicular to the alignment direction, from a reference position to be used when there is no change in the degree of spreading to be detected by the spreading detecting section, in accordance with the change in the degree of spreading.

A second aspect according to the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIGS. 4A and 4B are diagrams for describing a reference template setting method in the embodiment.

FIGS. 5A through 5C are diagrams for describing a distance detecting method in the embodiment.

FIGS. 6A and 6B are diagrams for describing verification as to how a dot pattern changes depending on a change in a wavelength in the embodiment.

FIGS. 7A through 7C are diagrams for describing a change in a dot pattern depending on a change in a wavelength in the embodiment.

FIGS. 8A through 8C are diagrams showing an offset setting method in the embodiment.

FIGS. 9A and 9B are flowcharts showing an offset setting processing in the embodiment.

FIGS. 10A through 10D are diagrams showing a method for detecting a displacement of a reference segment area in the embodiment.

FIGS. 11A and 11B are diagrams showing an offset processing example in the embodiment.

FIGS. 12A and 12B are respectively a configuration of an updated table, and a flowchart showing a template updating processing as a modification.

The drawings are provided mainly for describing the present invention, and do not limit the scope of the present invention.

### DESCRIPTION OF PREFERRED EMBODIMENTS

In the following, an embodiment of the invention is described referring to the drawings. The embodiment is an example, wherein the invention is applied to an information acquiring device which is configured to irradiate a target area with laser light having a predetermined dot pattern.

In the embodiment, a laser light source 111 corresponds to a “light source” in the claims. A DOE 114 corresponds to a “diffractive optical element” in the claims. A CMOS image sensor 124 corresponds to a “light receiving element” in the claims. A memory 25 corresponds to a “storage” in the claims. A three-dimensional distance calculator 21c corresponding to an “information acquiring section” in the claims. An updating section 21b corresponds to a “spreading detecting section” and an “information acquiring section” in the claims. The description regarding the correspondence between the claims and the embodiment is merely an example, and the claims are not limited by the description of the embodiment.

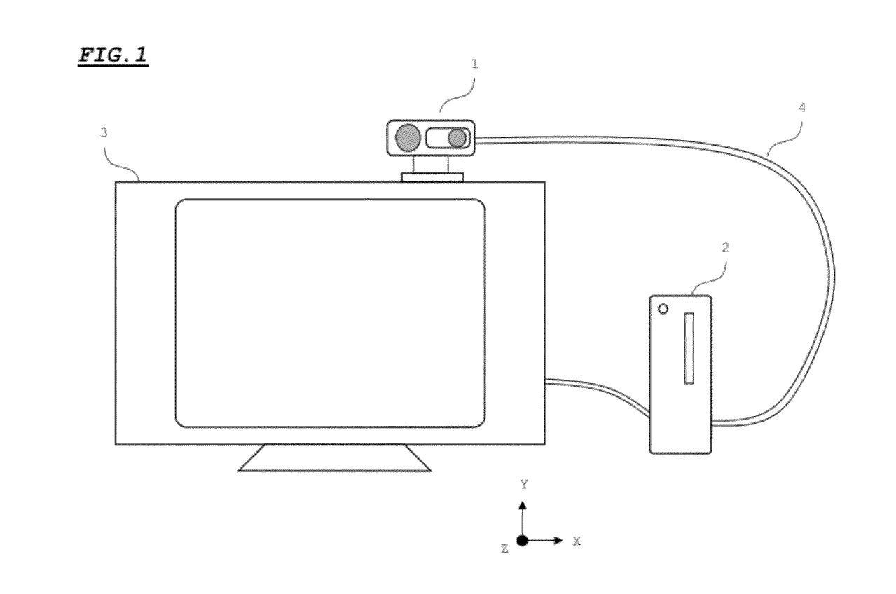

Firstly, a schematic arrangement of an object detecting device according to the first embodiment is described. As shown in FIG. 1, the object detecting device is provided with an information acquiring device 1, and an information processing device 2. A TV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

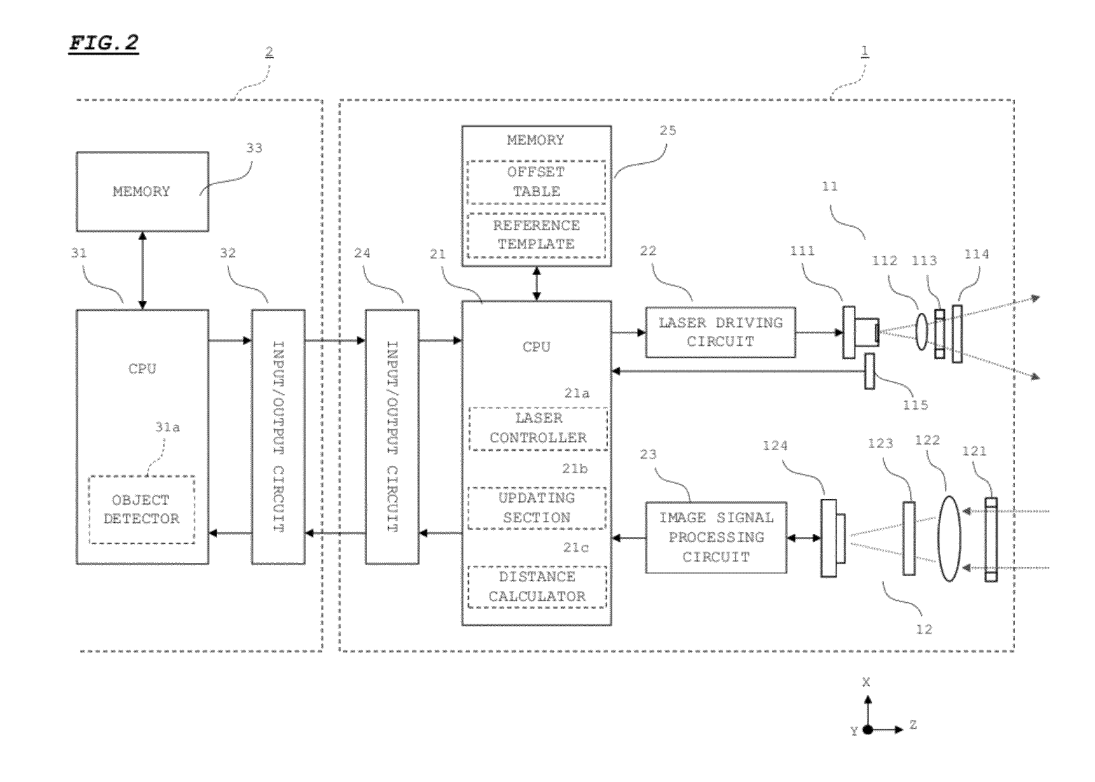

FIG. 2 is a diagram showing an arrangement of the information acquiring device 1 and the information processing device 2.

The information acquiring device 1 is provided with a projection optical system 11 and a light receiving optical system 12, which constitute an optical section. The projection optical system 11 and the light receiving optical system 12 are disposed in the information acquiring device 1 side by side in X-axis direction.

The projection optical system 11 is provided with a laser light source 111, a collimator lens 112, an aperture 113, and a diffractive optical element (DOE) 114. The projection optical system 11 is further provided with a temperature sensor 115. Further, the light receiving optical system 12 is provided with an aperture 121, an imaging lens 122, a filter 123, and a CMOS image sensor 124. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

The laser light source 111 outputs laser light in a narrow wavelength band of or about 830 nm. The collimator lens 112 converts the laser light emitted from the laser light source 111 into parallel light. The aperture 113 adjusts a light flux cross section of laser light into a predetermined shape.

The DOE 114 has a diffraction pattern on an incident surface thereof. Laser light entered to the DOE 114 through the aperture 113 is converted into laser light having a dot pattern by a diffractive action of the diffraction pattern, and is irradiated onto a target area. The diffractive pattern is formed to have a structure that a step-type diffractive hologram is formed with a predetermined pattern. The pattern and the pitch of the diffractive hologram are adjusted in such a manner that laser light collimated by the collimator lens 112 is converted into laser light having a dot pattern.

The DOE 114 irradiates a target area with laser light entered from the collimator lens 112, as laser light having a radially spreading dot pattern. The DOE 114 is constituted of a single optical element, wherein a diffractive pattern is formed only in one surface.

The temperature sensor 115 detects a temperature in the vicinity of the laser light source 111.

Laser light reflected on the target area is entered to the imaging lens 122 through the aperture 121. The aperture 121 converts external light into convergent light in accordance with the F-number of the imaging lens 122. The imaging lens 122 condenses the light entered through the aperture 121 on the CMOS image sensor 124.

The filter 123 is a band-pass filter which transmits light in a wavelength band including the emission wavelength band (in the range of about 830 nm) of the laser light source 111, and blocks light in a visible light wavelength band. The CMOS image sensor 124 receives light condensed on the imaging lens 122, and outputs a signal (electric charge) in accordance with a received light amount to the image signal processing circuit 23 pixel by pixel. In this example, the CMOS image sensor 124 is configured in such a manner that the output speed of signals to be outputted from the CMOS image sensor 124 is set high so that a signal (electric charge) at each pixel can be outputted to the image signal processing circuit 23 with high response from a light receiving timing at each pixel.

The CPU 21 controls the parts of the information acquiring device 1 in accordance with a control program stored in the memory 25. By the control program, the CPU 21 has functions of a laser controller 21a for controlling the laser light source 111, an updating section 21b to be described later, and a three-dimensional distance calculator 21c for generating three-dimensional distance information.

The laser driving circuit 22 drives the laser light source 111 in accordance with a control signal from the CPU 21. The image signal processing circuit 23 controls the CMOS image sensor 124 to successively read signals (electric charges) from the pixels, which have been generated in the CMOS image sensor 124, line by line. Then, the image signal processing circuit 23 outputs the read signals successively to the CPU 21. The CPU 21 calculates a distance from the information acquiring device 1 to each portion of an object to be detected, by a processing to be implemented by the three-dimensional distance calculator 21c, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

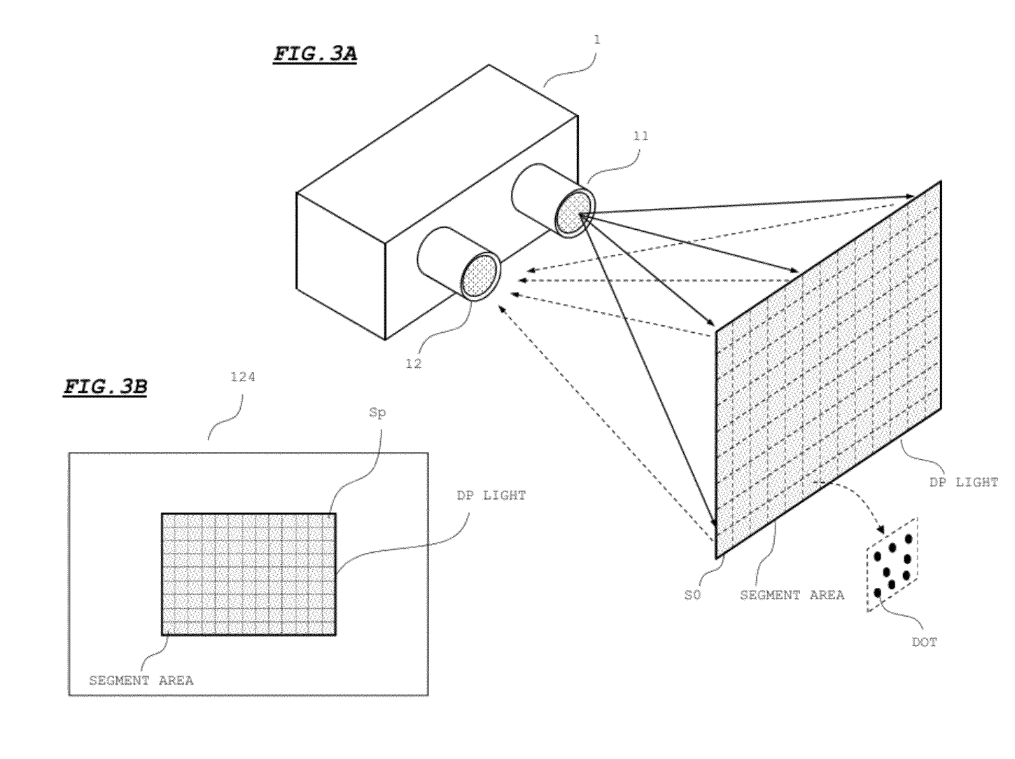

FIG. 3A is a diagram schematically showing an irradiation state of laser light onto a target area. FIG. 3B is a diagram schematically showing a light receiving state of laser light on the CMOS image sensor 124. To simplify the description, FIG. 3B shows a light receiving state in the case where a flat plane (screen) is disposed on a target area.

The projection optical system 11 irradiates a target area with laser light having a dot pattern (hereinafter, the entirety of the laser light having the dot pattern is called as “DP light”). FIG. 3A shows a light flux area of DP light by a solid-line frame. In the light flux of DP light, dot areas (hereinafter, simply called as “dots”) in which the intensity of laser light is increased by a diffractive action of the DOE 114 locally appear in accordance with the dot pattern by the diffractive action of the DOE 114.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 124, as shown in FIG. 3B. For instance, light of a segment area S0 in the target area shown in FIG. 3A is entered to a segment area Sp shown in FIG. 3B, on the CMOS image sensor 124. In FIG. 3B, a light flux area of DP light is also indicated by a solid-line frame, and to simplify the description, a light flux of DP light is divided into segment areas arranged in the form of a matrix in the same manner as shown in FIG. 3A.

The three-dimensional distance calculator 21c is operable to detect a position of each segment area on the CMOS image sensor 124 for detecting a distance to a position of an object to be detected corresponding to the segment area, based on the detected position of the segment area, using a triangulation method. The details of the above detection method is disclosed in e.g. pp. 1279-1280, the 19th Annual Conference Proceedings (Sep. 18-20, 2001) by the Robotics Society of Japan.

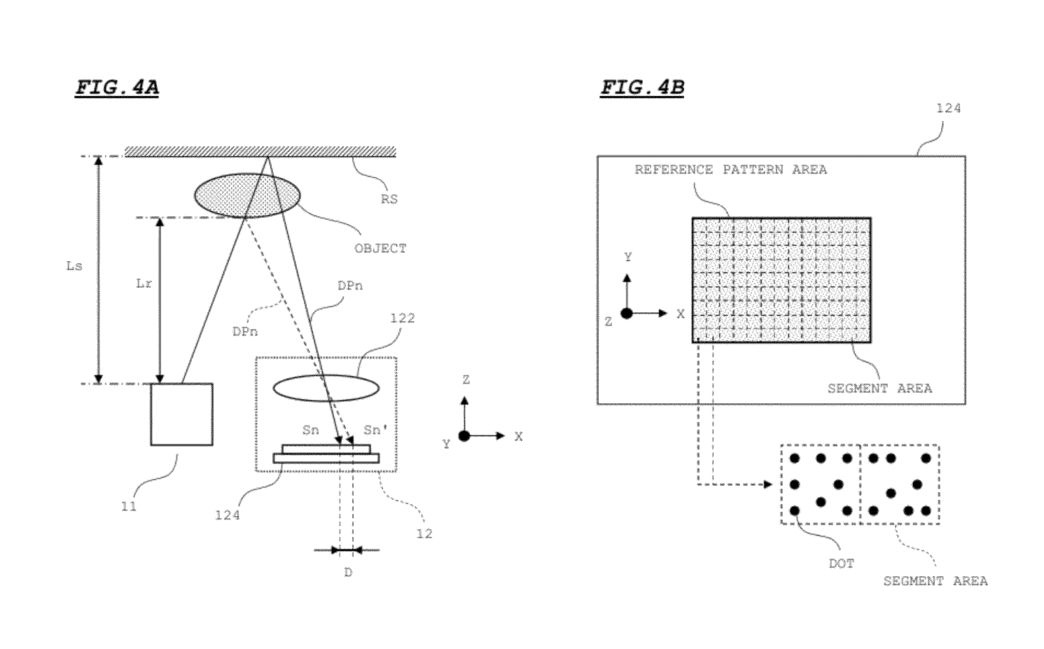

FIGS. 4A, 4B are diagrams schematically showing a reference template generation method for use in the aforementioned distance detection.

As shown in FIG. 4A, at the time of generating a reference template, a reflection plane RS perpendicular to Z-axis direction is disposed at a position away from the projection optical system 11 by a predetermined distance Ls. Then, DP light is emitted from the projection optical system 11 for a predetermined time Te in the above state. The emitted DP light is reflected on the reflection plane RS, and is entered to the CMOS image sensor 124 in the light receiving optical system 12. By performing the above operation, an electrical signal at each pixel is outputted from the CMOS image sensor 124. The value (pixel value) of the electrical signal at each outputted pixel is expanded in the memory 25 shown in FIG. 2. In the following, to simplify the description, the description is made based on an irradiation state of DP light which is irradiated onto the CMOS image sensor 124, in place of a pixel value expanded in the memory 25.

As shown in FIG. 4B, a reference pattern area for defining an irradiation area of DP light on the CMOS image sensor 124 is set, based on the pixel values expanded in the memory 25. Further, the reference pattern area is divided into segment areas in the form of a matrix. As described above, dots locally appear with a unique pattern in each segment area. Accordingly, each segment area has a different pattern of pixel values. Each one of the segment areas has the same size as all the other segment areas.

The reference template is configured in such a manner that pixel values of the pixels included in each segment area set on the CMOS image sensor 124 are correlated to the segment area.

Specifically, the reference template includes information relating to the position of a reference pattern area on the CMOS image sensor 124, pixel values of all the pixels included in the reference pattern area, and information for use in dividing the reference pattern area into segment areas. The pixel values of all the pixels included in the reference pattern area correspond to a dot pattern of DP light included in the reference pattern area. Further, pixel values of pixels included in each segment area are acquired by dividing a mapping area on pixel values of all the pixels included in the reference pattern area into segment areas. The reference template may retain pixel values of pixels included in each segment area, for each segment area.

The reference template thus configured is stored in the memory 25 shown in FIG. 2 in a non-erasable manner. The reference template stored in the memory 25 is referred to in calculating a distance from the projection optical system 11 to each portion of an object to be detected.

For instance, in the case where an object is located at a position nearer to the distance Ls shown in FIG. 4A, DP light (DPn) corresponding to a segment area Sn on the reference pattern is reflected on the object, and is entered to an area Sn′ different from the segment area Sn. Since the projection optical system 11 and the light receiving optical system 12 are adjacent to each other in X-axis direction, the displacement direction of the area Sn′ relative to the segment area Sn is aligned in parallel to X-axis. In the case shown in FIG. 4A, since the object is located at a position nearer to the distance Ls, the area Sn′ is displaced relative to the segment area Sn in plus X-axis direction. If the object is located at a position farther from the distance Ls, the area Sn′ is displaced relative to the segment area Sn in minus X-axis direction.

A distance Lr from the projection optical system 11 to a portion of the object irradiated with DP light (DPn) is calculated, using the distance Ls, and based on a displacement direction and a displacement amount of the area Sn′ relative to the segment area Sn, by a triangulation method. A distance from the projection optical system 11 to a portion of the object corresponding to the other segment area is calculated in the same manner as described above.

In performing the distance calculation, it is necessary to detect to which position, a segment area Sn of the reference template has displaced at the time of actual measurement. The detection is performed by performing a matching operation between a dot pattern of DP light irradiated onto the CMOS image sensor 124 at the time of actual measurement, and a dot pattern included in the segment area Sn.

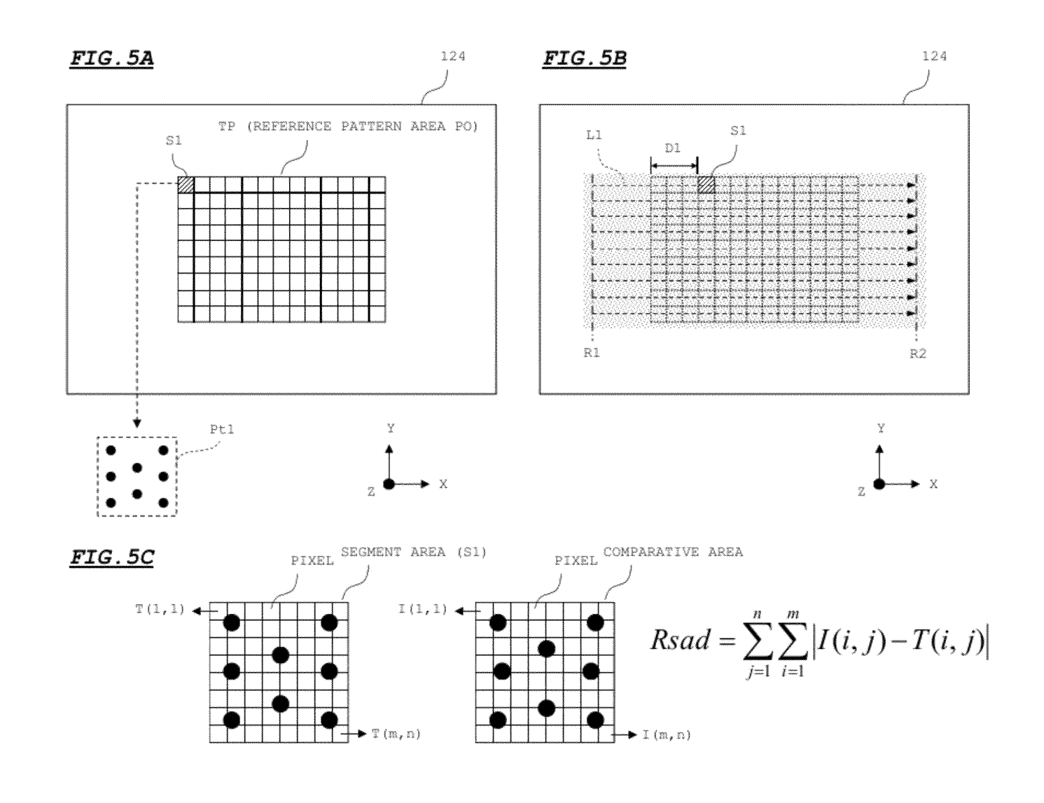

FIGS. 5A through 5C are diagrams for describing the aforementioned detection method. FIG. 5A is a diagram showing a state as to how a reference template TP (reference pattern area P0) is set on the CMOS image sensor 124, FIG. 5B is a diagram showing a segment area searching method to be performed at the time of actual measurement, and FIG. 5C is a diagram showing a matching method between an actually measured dot pattern of DP light, and a dot pattern included in a segment area of a reference template TP.

For instance, in the case where a displacement position of a segment area S1 at the time of actual measurement shown in FIG. 5A is searched, as shown in FIG. 5B, the segment area S1 is fed pixel by pixel in X-axis direction in a range from R1 to R2 on the CMOS image sensor 124 for obtaining a matching degree between the dot pattern of the segment area S1, and the actually measured dot pattern of DP light, at each feeding position. In this case, the segment area S1 is fed in X-axis direction only on a line L1 passing an uppermost segment area group in the reference template TP (reference pattern area P0). This is because, as described above, each segment area is normally displaced only in X-axis direction from a position on the reference pattern area P0 at the time of actual measurement. In other words, the segment area S1 is conceived to be on the uppermost line L1. By performing a searching operation only in X-axis direction as described above, the processing load for searching is reduced.

At the time of actual measurement, a segment area may be deviated in X-axis direction from the range of the reference pattern area P0 on the reference template TP, depending on the position of an object to be detected. In view of the above, the range from R1 to R2 is set wider than the X-axis directional width of the reference pattern area P0.

At the time of detecting the matching degree, an area (comparative area) of the same size as the segment area S1 is set on the line L1, and a degree of similarity between the comparative area and the segment area S1 is obtained. Specifically, there is obtained a difference between the pixel value of each pixel in the segment area S1, and the pixel value of a pixel, in the comparative area, corresponding to the pixel in the segment area S1. Then, a value Rsad which is obtained by summing up the difference with respect to all the pixels in the comparative area is acquired as a value representing the degree of similarity.

For instance, as shown in FIG. 5C, in the case where pixels of m columns by n rows are included in one segment area, there is obtained a difference between a pixel value T(i, j) of a pixel at i-th column, j-th row in the segment area, and a pixel value I(i, j) of a pixel at i-th column, j-th row in the comparative area. Then, a difference is obtained with respect to all the pixels in the segment area, and the value Rsad is obtained by summing up the differences. In other words, the value Rsad is calculated by the following formula.

$$Rsad = {\sum }_{j = 1}^{n} {\sum }_{i = 1}^{m} \vert I ( i , j ) - T ( i , j ) \vert \qquad ( 1 )$$

As the value Rsad is smaller, the degree of similarity between the segment area and the comparative area is high.

At the time of a searching operation, the comparative area is sequentially set in a state that the comparative area is displaced pixel by pixel on the line L1. Then, the value Rsad is obtained for all the comparative areas on the line L1. A value Rsad smaller than a threshold value is extracted from among the obtained values Rsad. In the case where there is no value Rsad smaller than the threshold value, it is determined that the searching operation of the segment area S1 has failed. In this case, a comparative area having a smallest value among the extracted values Rsad is determined to be the area to which the segment area S1 has moved. The segment areas other than the segment area S1 on the line L1 are searched in the same manner as described above. Likewise, segment areas on the other lines are searched in the same manner as described above by setting a comparative area on the other line.

In the case where the displacement position of each segment area is searched from the dot pattern of DP light acquired at the time of actual measurement in the aforementioned manner, as described above, the distance to a portion of the object to be detected corresponding to each segment area is obtained based on the displacement positions, using a triangulation method.

The dot pattern of DP light may vary depending on the shape or the position of the DOE 114, and the wavelength of laser light to be emitted from the laser light source 111. However, these factors are likely to change depending on a temperature, and may change as time elapses. In particular, in the case where the DOE 114 is made of a resin material, the characteristic of the DOE 114 is likely to change depending on a temperature. The dot pattern is also likely to change, as the characteristic of the DOE 114 changes or the wave length of the laser light changes. If the dot pattern changes as described above, it is impossible to accurately perform a matching operation between the dot pattern at the time of actual measurement, and the dot pattern retained in the reference template. As a result, detection precision of a distance to the object to be detected may be lowered.

Generally, the diffractive angle θ of a diffractive pattern is obtained by the following equation.

θ=arcsin(λ/p)

where λ is the wavelength of laser light, and p is the pitch of a diffractive pattern. The above equation shows that the diffractive angle θ increases, as the wavelength θ of laser light increases; and that the diffractive angle θ decreases, as the pitch p of the diffractive pattern increases.

As described above, the DOE 114 to be used in this embodiment is constituted of a single optical element, wherein a diffractive pattern is formed only in one surface. The inventor of the present application has performed measurements regarding how a dot pattern changes depending on a change in a wavelength of laser light, in the case where the DOE 114 is configured as described above.

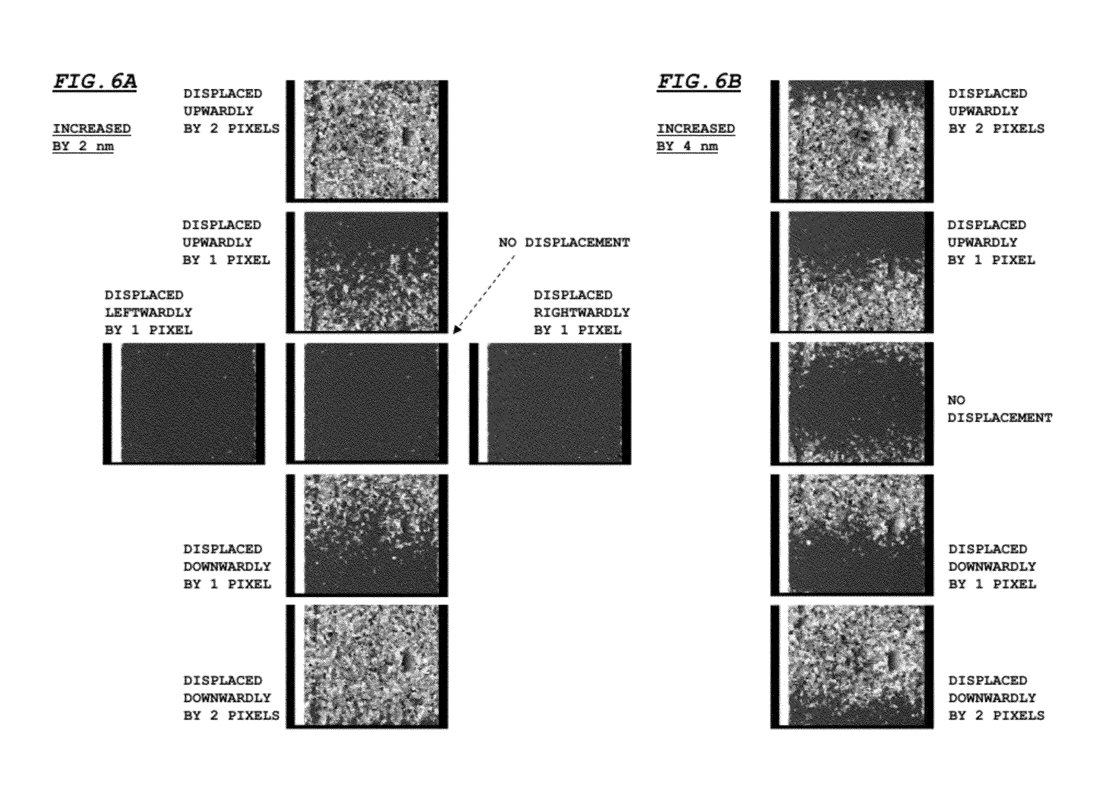

FIGS. 6A and 6B are diagrams showing measurement results, in the case where the wavelength of laser light is increased from a reference wavelength by 2 nm and by 4 nm, respectively. In the measurements, a dot pattern (reference dot pattern) retained as a reference template was irradiated onto a flat reflection plane. Then, matching measurement was performed between the dot pattern irradiated onto the CMOS image sensor 124 in the above condition, and the reference dot pattern. As described referring to FIG. 5B, the matching operation was performed by obtaining a value Rsad of the formula (1) with respect to a segment area and with respect to a comparative area, while moving the comparative area in right direction pixel by pixel, and by determining whether a value smaller than a threshold value was extracted from among the obtained values Rsad. Then, in the case where the extraction was impossible, it was determined that the segment area was an error area.

The moving range of the comparative area was set to a range corresponding to 60 pixels horizontally, based on a position where a dot in a segment area corresponding to the comparative area, which has been reflected on the reflection plane, was presumed to be irradiated onto the CMOS image sensor 124, as a center.

Further, in FIG. 5A, segment areas adjacent to each other were set without overlapping. In the measurement, however, the segment area immediately on the right side of the segment area S1 in FIG. 5A is an area obtained by displacing the segment area S1 in right direction by 1 pixel, and the segment area S1 and the segment area immediately on the right side of the segment area S1 have a portion overlapping each other. Likewise, the other respective segment area, and segment areas adjacent to the other respective segment area horizontally also have a portion overlapping each other. Likewise, segments areas adjacent to each other vertically also have a portion overlapping each other.

The seven screens in FIG. 6A show matching results by the aforementioned measurement. Segment areas in which matching was not obtained are indicated by white spots in the reference pattern area of the reference template.

The middle screen in FIG. 6A shows a measurement result, in the case where an area (hereinafter, called as a “determination target area”) on the CMOS image sensor 124, for which matching determination is performed, was defined as an ordinary area. The left and right screens with respect to the middle screen respectively show measurement results, in the case where the determination target area was displaced from the ordinary area leftwardly and rightwardly by 1 pixel. The upper two screens with respect to the middle screen respectively show measurement results, in the case where the determination target area was displaced from the ordinary area upwardly by 1 pixel and by 2 pixels. The lower two screens with respect to the middle screen respectively show measurement results, in the case where the determination target area was displaced from the ordinary area downwardly by 1 pixel and by 2 pixels.

Referring to the middle screen in FIG. 6A, it is clear that matching is substantially obtained with respect to all the regions in the reference pattern area. This means that the dot pattern to be irradiated onto the CMOS image sensor 124 does not greatly change, even if the wavelength of the laser light source 111 changes from the reference wavelength by about 2 nm. Specifically, it is conceived that an upward/downward shift amount of a dot pattern resulting from a wavelength variation lies in a range in which matching is obtained with respect to all the regions in the reference pattern area. Normally, as far as an upward/downward shift amount of a dot pattern is smaller than 1 pixel, matching can be obtained.

Referring to the immediately upper screen with respect to the middle screen in FIG. 6A, it is clear that matching is not obtained between a vertically middle region in the reference pattern area, and a lower region of the middle region, in the case where the determination target area is displaced upwardly by 1 pixel. This is because by displacing the determination target area upwardly from the state of the middle screen by 1 pixel, a shift amount of the dot pattern becomes equal to or larger than 1 pixel in the middle region and in the lower region. On the other hand, it is clear that matching is obtained, as the dot pattern is shifted upwardly, with respect to the upper region of the vertically middle region in the reference pattern area. This is conceivably because the dot pattern is shifted upwardly in the range of 1 pixel or smaller in the state of the middle screen in FIG. 6A, the shift amount of the dot pattern lies in the range of 1 pixel or smaller, even if the determination target area is displaced upwardly by 1 pixel from the state of the middle screen. The above result verifies that the dot pattern to be irradiated onto the CMOS image sensor 124 is shifted upwardly, as the dot pattern is directed upwardly from the middle, in the case where the wavelength of the laser light source 111 is increased from the reference wavelength by 2 nm.

Referring to the uppermost screen in FIG. 6A, it is clear that matching is not obtained with respect to all the regions in the reference pattern area, in the case where the determination target area is displaced upwardly by 2 pixels. This means that a shift amount of the dot pattern resulting from a wavelength variation also lies in the range of 1 pixel in a region at an upper end of the reference pattern area.

Referring to the immediately lower screen with respect to the middle screen in FIG. 6A, it is clear that matching is not obtained between a vertically middle region in the reference pattern area, and an upper region of the middle region, in the case where the determination target area is displaced downwardly by 1 pixel. This is because by displacing the determination target area downwardly from the state of the middle screen by 1 pixel, a shift amount of the dot pattern exceeds 1 pixel in the middle region and in the upper region. On the other hand, it is clear that matching is obtained, as the dot pattern is shifted downwardly with respect to a lower region of the vertically middle region in the reference pattern area. This is conceivably because the dot pattern is shifted downwardly in the range of 1 pixel or smaller in the state of the middle screen in FIG. 6A, the shift amount of the dot pattern lies in the range of 1 pixel or smaller, even if the determination target area is displaced downwardly by 1 pixel from the state of the middle screen. The above result verifies that the dot pattern to be irradiated onto the CMOS image sensor 124 is shifted downwardly, as the dot pattern is directed downwardly from the middle, in the case where the wavelength of the laser light source 111 is increased from the reference wavelength by 2 nm.

Referring to the lowermost screen in FIG. 6A, it is clear that matching is not obtained with respect to all the regions in the reference pattern area, in the case where the determination target area is displaced downwardly by 2 pixels. This means that a shift amount of the dot pattern resulting from a wavelength variation also lies in the range of 1 pixel in a region at a lower end of the reference pattern area.

Referring to the left and right screens with respect to the middle screen in FIG. 6A, it is clear that matching is obtained in all the regions in the reference pattern area, even in the case where the determination target area is displaced leftwardly or rightwardly by 1 pixel. This is conceivably because matching determination between a segment area and a comparative area is performed while displacing the comparative area leftwardly or rightwardly, no matter how the dot pattern is displaced leftwardly or rightwardly resulting from a wavelength variation, or no matter how the determination target area is displaced leftwardly or rightwardly by a distance corresponding to about 1 pixel, matching is obtained. Thus, it is unknown, from the left and right screens with respect to the middle screen, whether the dot pattern to be irradiated onto the CMOS image sensor 124 is shifted leftwardly or rightwardly, resulting from an increase in the wavelength of the laser light source 111 from the reference wavelength by 2 nm.

Next, referring to the middle screen in FIG. 6B, it is clear that matching is substantially obtained in a vertically middle region in the reference pattern area; and matching is not obtained, as the dot pattern is directed upwardly or downwardly with respect to the middle region. This means that in the case where the wavelength of the laser light source 111 changes from the reference wavelength by about 4 nm, the dot pattern on the CMOS image sensor 124 is shifted upwardly or downwardly, as the dot pattern is directed upwardly or downwardly. Further, comparing between the middle screen shown in FIG. 6B and the middle screen shown in FIG. 6A, it is clear that an upward or downward shift amount of the dot pattern on the CMOS image sensor 124 increases, as the wavelength variation increases.

Referring to the immediately upper screen with respect to the middle screen in FIG. 6B, it is clear that matching is not obtained between a vertically middle region in the reference pattern area, and a lower region of the middle region, in the case where the determination target area is displaced upwardly by 1 pixel. This is because by displacing the determination target area from the state of the middle screen upwardly by 1 pixel, a shift amount of the dot pattern exceeds 1 pixel in the middle region and in the lower region. On the other hand, it is clear that matching is obtained in a segment area in the upper region in the reference pattern area, corresponding to an error area in the middle screen in FIG. 6B. This means that a shift amount of the dot pattern in the upper region is reduced from a value equal to or larger than 1 pixel to a value smaller than 1 pixel by displacing the determination target area upwardly by 1 pixel.

Referring to the uppermost screen in FIG. 6B, matching is still obtained in the uppermost region, even if the determination target area is displaced upwardly by 2 pixels. Comparing between the uppermost screen and the immediately lower screen, it is clear that an upward shift amount of the dot pattern on the CMOS image sensor 124 is large, as the dot pattern is directed upwardly.

Referring to the immediately lower screen with respect to the middle screen in FIG. 6B, it is clear that matching is not obtained in a vertically middle region in the reference pattern area, and an upper region of the middle region, in the case where the determination target area is displaced downwardly by 1 pixel. This is because by displacing the determination target area from the state of the middle screen downwardly by 1 pixel, a shift amount of the dot pattern exceeds 1 pixel in the middle region and in the upper region. On the other hand, it is clear that matching is obtained in a segment area in the upper region in the reference pattern area, corresponding to an error area in the middle screen in FIG. 6B. This means that a shift amount of the dot pattern in the upper region is reduced from a value equal to or larger than 1 pixel to a value smaller than half pixel by displacing the determination target area upwardly by 1 pixel.

Referring to the lowermost screen in FIG. 6B, matching is still obtained in the lowermost region, even if the determination target area is displaced downwardly by 2 pixels. Comparing between the lowermost screen and the immediately upper screen, it is clear that a downward shift amount of the dot pattern on the CMOS image sensor 124 is large, as the dot pattern is directed downwardly.

The following matters are clarified from the aforementioned measurement results.

(1) As the wavelength increases, the dot pattern on the CMOS image sensor 124 is shifted upwardly or downwardly.

(2) A shift amount of the dot pattern resulting from a wavelength variation increases, as the dot pattern is directed upwardly or downwardly.

It was impossible to directly determine whether the dot pattern was shifted leftwardly or rightwardly resulting from a wavelength variation, based on the aforementioned measurements. However, it is conceived that there is the same tendency horizontally as well as vertically, in view of the characteristic of the diffractive pattern. Therefore, the following matters can also be predicted.

(3) As the wavelength increases, the dot pattern on the CMOS image sensor 124 is shifted leftwardly or rightwardly.

(4) A shift amount of the dot pattern resulting from a wavelength variation increases, as the dot pattern is directed rightwardly or leftwardly.

The inventor of the present application photographed images of the behavior of the dot pattern to be irradiated onto the CMOS image sensor 124, while changing the wavelength of the laser light source 111. The photographs reveal that the dot pattern to be irradiated onto the CMOS image sensor 124 is shifted radially from the center of the dot pattern area, resulting from a wavelength variation of the laser light source 111.

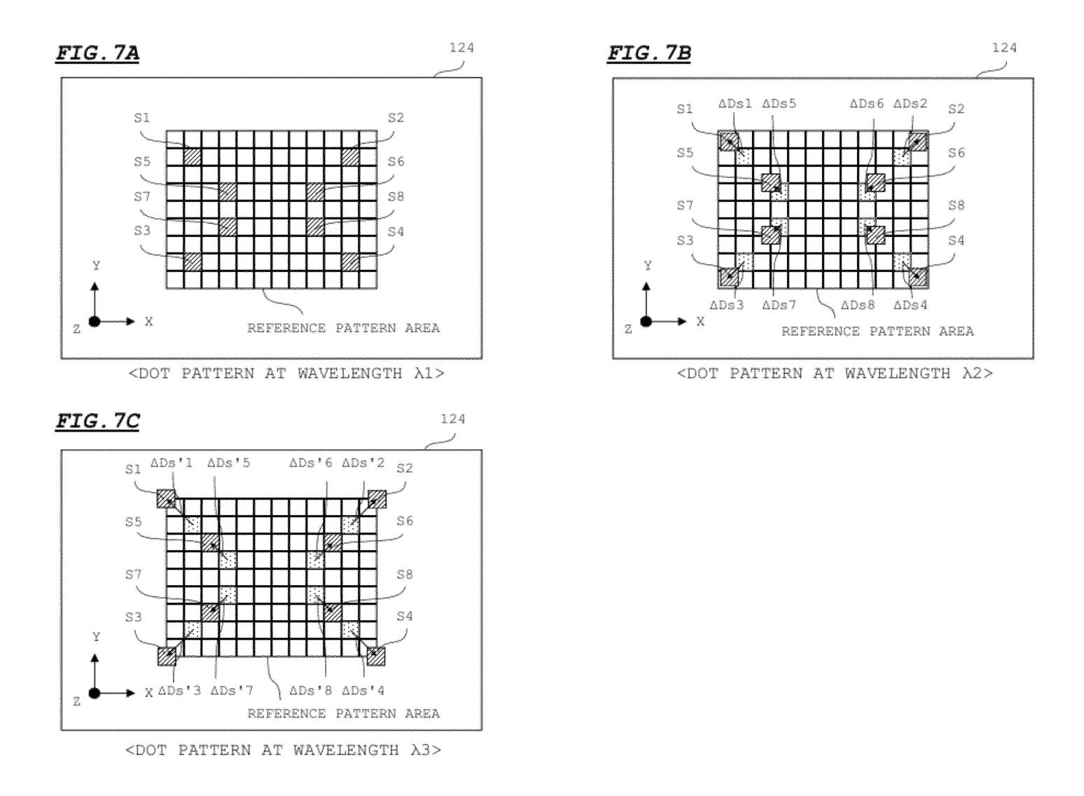

FIGS. 7A through 7C are diagrams schematically showing how each segment area in the reference pattern area is displaced depending on a wavelength, based on the aforementioned measurement results. To simplify the description, only a part of segment areas is shown in FIGS. 7A through 7C.

FIG. 7A shows segment areas 51 through S8 in the case where the wavelength is set to λ1 (reference wavelength).

FIG. 7B shows segment areas 51 through S8 in the case where the wavelength of laser light is shifted toward a long wavelength region resulting from e.g. a temperature increase, and the wavelength is set to λ2 (λ1<λ2). In this case, as described above referring to FIGS. 6A and 6B, the segment areas S1 through S8 are shifted radially outwardly from the center of the reference pattern area, as compared with the case shown in FIG. 7A. Further, displacement amounts ΔDs1 through ΔDs4 of the segment areas S1 through S4 near the outer periphery of the reference pattern area are larger than displacement amounts ΔDs5 through ΔDs8 of the segment areas S5 through S8 near the center portion of the reference pattern area.

FIG. 7C shows segment areas S1 through S8, in the case where the wavelength of laser light is shifted further toward the long wavelength region resulting from e.g. a further temperature increase, and the wavelength is set to λ3 (λ1<λ2<λ3). In this case, the segment areas S1 through S8 are shifted further outwardly from the center of the reference pattern area, as compared with the case shown in FIG. 7B. Further, displacement amounts ΔDs′1 through ΔDs′8 of the segment areas S1 through S8 are large, as compared with the case shown in FIG. 7B.

As described above, in the case where the DOE 114 is used, as the wavelength of laser light is shifted toward a long wavelength region, the segment areas are shifted outwardly. Further, the displacement amount of a segment area increases, as the segment area is located outwardly of the reference pattern area. Further, each segment area is displaced substantially symmetrically (radially) with respect to the center of the reference pattern area.

The displacement amount of each segment area depends on a wavelength variation of laser light. Accordingly, it is possible to calculate the position of each segment area in Y-axis direction, based on the wavelength of laser light. This characteristic appears in the same manner as described above, as far as a DOE is constituted of a single layer having a diffractive pattern, and does not change depending on the diffractive pattern of the DOE 114.

In this embodiment, a displacement amount of a segment area in Y-axis direction is detected at the time of actual measurement, utilizing the aforementioned characteristic, and a scanning line for use in searching a segment area is offset in Y-axis direction in accordance with the detected displacement amount. Specifically, a displacement amount of a predetermined segment area (reference segment area) in a reference template TP in Y-axis direction is detected, and an offset direction and an offset amount are set depending on the detection result.

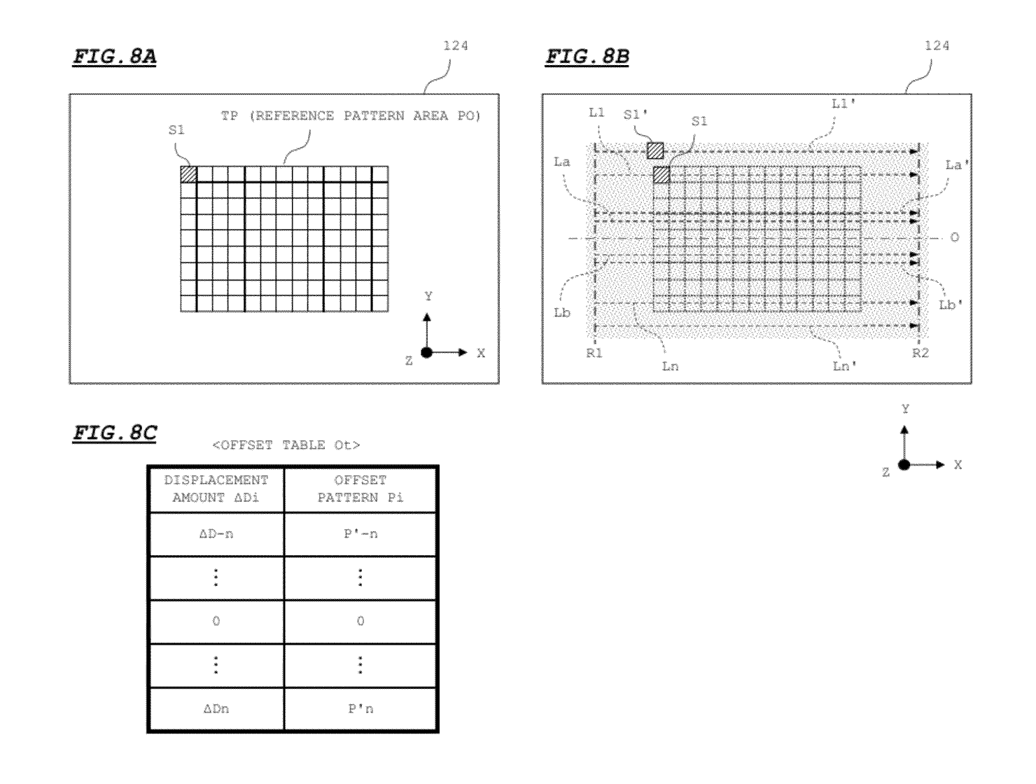

FIGS. 8A through 8C are diagrams showing an offset setting method.

For instance, a segment area S1 shown in FIG. 8A is set as a reference segment area. In this case, as shown in FIG. 8B, assuming that the segment area S1 is displaced to a position S1′ at the time of actual measurement, a segment area searching line L1 at an uppermost row in the reference template TP is offset upwardly, and L1′ is set as a searching line. Further, a segment area searching line La at an upper position from a center line O by one row is offset upwardly, and La′ is set as a searching line. Likewise, a segment area searching line Lb at a lower position from the center line O by one row is offset downwardly, and Lb′ is set as a searching line, and a segment area searching line Ln at a lowermost row is offset downwardly, and Ln′ is set as a searching line.

The offset amount of a searching line of each row increases, as the row is located farther from the center line. The offset amount of a searching line at each row is set by calculating a displacement amount of a segment area at each row in Y-axis direction, based on the displacement amount of the segment area S1 so that the offset amount coincides with the calculated displacement amount. The vertical offset amounts of searching lines corresponding to rows away from the center line by a certain distance are equal to each other. A certain shift amount may be set for plural rows vertically adjacent to each other. In the modification, the offset amount is set in such a manner that the offset amount is increased, as the row is located farther from the center line.

As described above, by shifting a searching line at each row in the reference template, even in the case where a wavelength variation of laser light has occurred at the time of actual measurement, and the irradiation area of the dot pattern onto the CMOS image sensor 124 changes, matching error in each segment area is less likely to occur. Thus, it is possible to smoothly detect an object.

FIG. 8C is a diagram showing an offset table Ot for use in setting an offset of a searching line. The offset table Ot is stored in advance in the memory 25.

An offset pattern is held in the offset table Ot in correlation to a displacement amount (ΔDi) of a reference segment area in Y-axis direction. The displacement amount ΔDi has plus sign or minus sign to indicate in which direction, i.e. plus Y-axis direction (expanding direction) or minus Y-axis direction (contracting direction), a reference segment area is displaced from a position (reference position) defined by the reference template. If the sign is plus, the reference segment area is displaced in plus Y-axis direction (expanding direction) from the reference position, and if the sign is minus, the reference segment area is displaced in minus Y-axis direction (contracting direction) from the reference position. The displacement amount has minus sign when the displacement amount is from ΔD-1 to ΔD-n, and the displacement amount has plus sign when the displacement amount is from ΔD1 to ΔDn. An offset pattern Pi holds therein an offset (offset amount and offset direction) of a searching line to be applied to the segment area at each row in the reference template TP when the corresponding displacement amount is ΔDi.

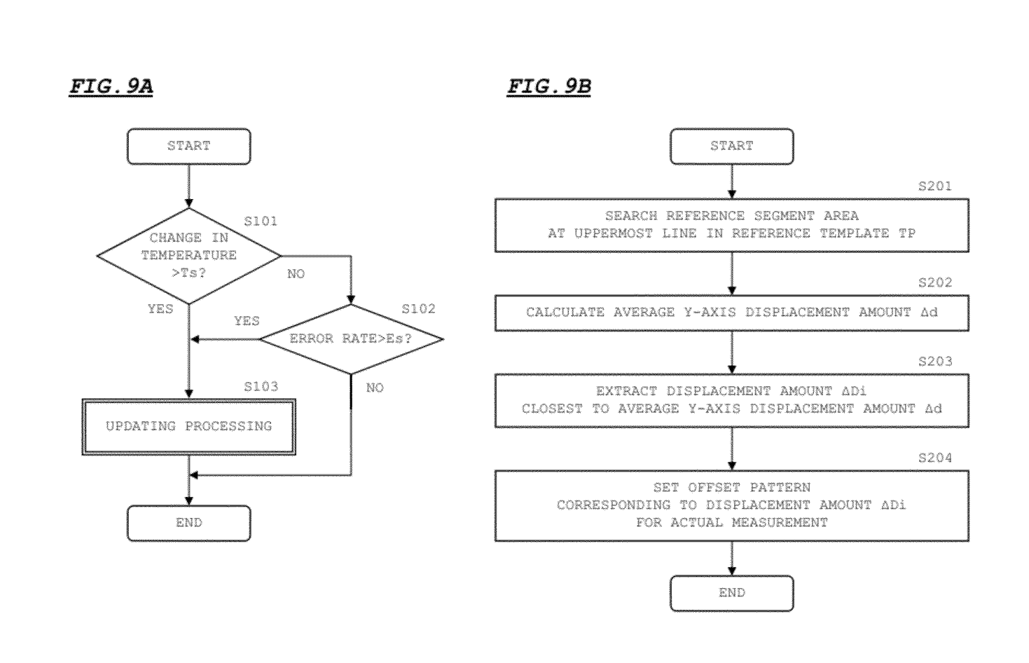

FIGS. 9A, 9B are diagrams showing a processing to be performed when a template is updated. The processing shown in FIGS. 9A, 9B is performed by an updating section 21b shown in FIG. 2. The updating section 21b performs the processing shown in FIGS. 9A, 9B at a predetermined time interval at the time of actual measurement.

Referring to FIG. 9A, the updating section 21b determines whether a difference between a temperature (previous temperature) acquired by the temperature sensor 115 at the time of a previous updating operation, and a temperature (current temperature) currently detected by the temperature sensor 115 has exceeded a threshold value Ts (S101). At the time of activation of the information acquiring device 1, it is determined whether a difference between a reference temperature at the time of configuring a reference template TP, and a current temperature has exceeded the threshold value Ts.

If the judgment result in S101 is affirmative, an updating processing of the template is performed (S103). If the judgment result in S101 is negative, it is determined whether a ratio of segment areas indicating that a searching operation has failed relative to all the segment areas has exceeded a threshold value Es in a segment area searching operation at the time of a most recent actual measurement. If the judgment result in S102 is affirmative, the updating processing of the template is performed (S103), and the judgment result in S102 is negative, template updating is finished.

FIG. 9B is a flowchart showing the updating processing in S103 shown in FIG. 9A. The processing shown in FIG. 9B is performed by referring to the aforementioned reference template TP stored in advance in the memory 25, and dot pattern information acquired at the time of actual measurement and expanded in the memory 25. As described above, the reference template TP includes information relating to the position of a reference pattern area P0, pixel values of all the pixels included in the reference pattern area P0, and information for use in dividing the reference pattern area P0 into segment areas. In the following, description is made based on a dot pattern for simplifying the description.

Referring to FIG. 9B, the updating section 21b searches a displacement position of a predetermined reference segment area from the dot pattern of DP light on the CMOS image sensor 124 at the time of actual measurement (S201).

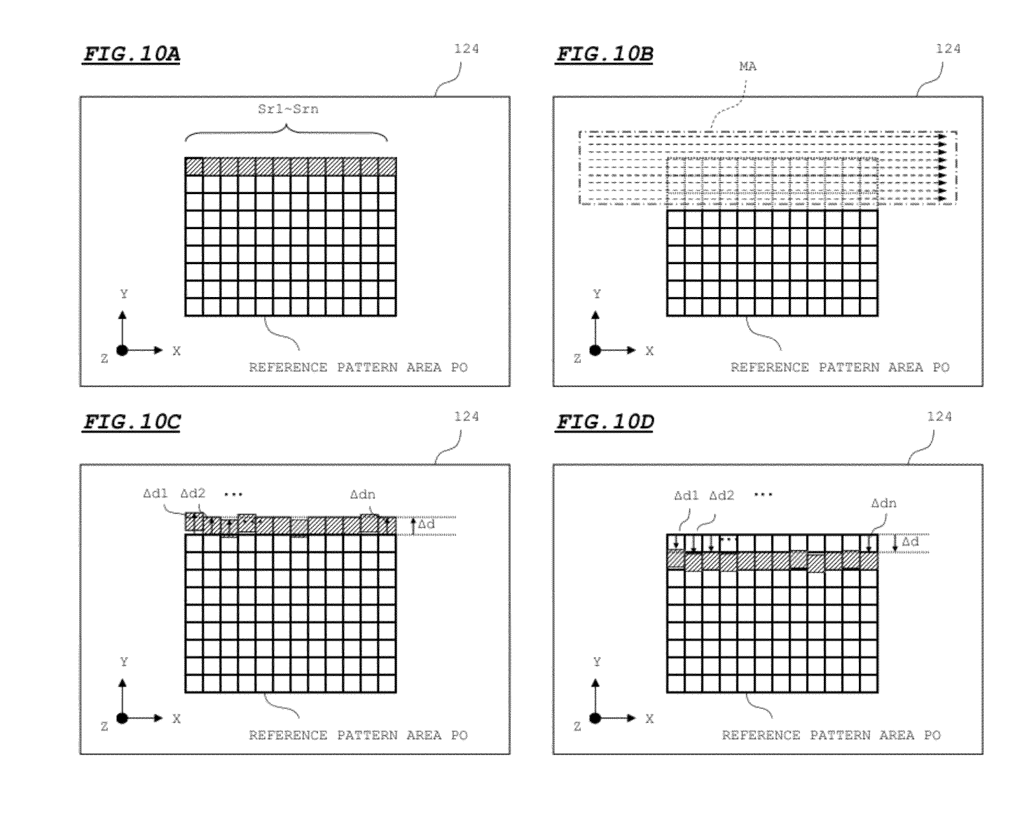

In this embodiment, as shown in FIG. 10A, segment areas at the uppermost row in a reference pattern area P0 of the reference template TP are set as reference segment areas Sr1 through Srn. A searching operation is performed as to which position in a searching area MA shown in FIG. 10B, these reference segment areas Sr1 through Srn are located. The searching area MA covers an area large enough for the uppermost row in a light receiving area of the CMOS image sensor 124. Further, the searching operation is performed for each of the reference segment areas Sr1 through Srn by performing a matching operation with respect to the entirety of the searching area MA. Specifically, after a searching operation is performed for an uppermost row in the searching area MA, a searching operation is performed for a succeeding row lower than the uppermost row by 1 pixel. Thus, a searching operation is successively performed for a lower row in the same manner as described above. The searching operation is performed in the same manner as described above referring to FIG. 5C. By performing the above operation, as shown in FIG. 10C or FIG. 10D, displacement amounts Δd1 through Δdn of the reference segment areas Sr1 through Srn at the uppermost row in Y-axis direction are acquired.

Referring back to FIG. 9B, in S201, in the case where the displacement amounts Δd1 through Δdn of the reference segment areas Sr1 through Srn in Y-axis direction are acquired, the updating section 21b calculates an average Y-axis displacement amount Δd based on the acquired displacement amounts Δd1 through Δdn in Y-axis direction (S202).

As shown in FIGS. 7A through 7C, the displacement amount of a segment area increases, as the segment area is located outwardly of the reference pattern area P0. Accordingly, it is desirable to set the reference segment areas Sr1 through Srn at an uppermost row as described in the embodiment, or set the reference segment areas Sr1 through Srn at a lowermost row. Further, as shown in FIGS. 10C and 10D, the displacement amounts of the reference segment areas Sr1 through Srn may include error resulting from an ambient light component or the like. In view of the above, it is desirable to acquire Y-axis displacement amounts of a predetermined number of reference segment areas, and set an average of these displacement amounts as a displacement amount in Y-axis direction as described in S201 and S202.

Then, the updating section 21b extracts a displacement amount ΔDi closest to the acquired average Y-axis displacement amount Δd from the offset table Ot shown in FIG. 8C (S203). Then, the updating section 21b sets an offset pattern Pi corresponding to the extracted displacement amount ΔDi, as an offset pattern to be used at the time of actual measurement (S204).

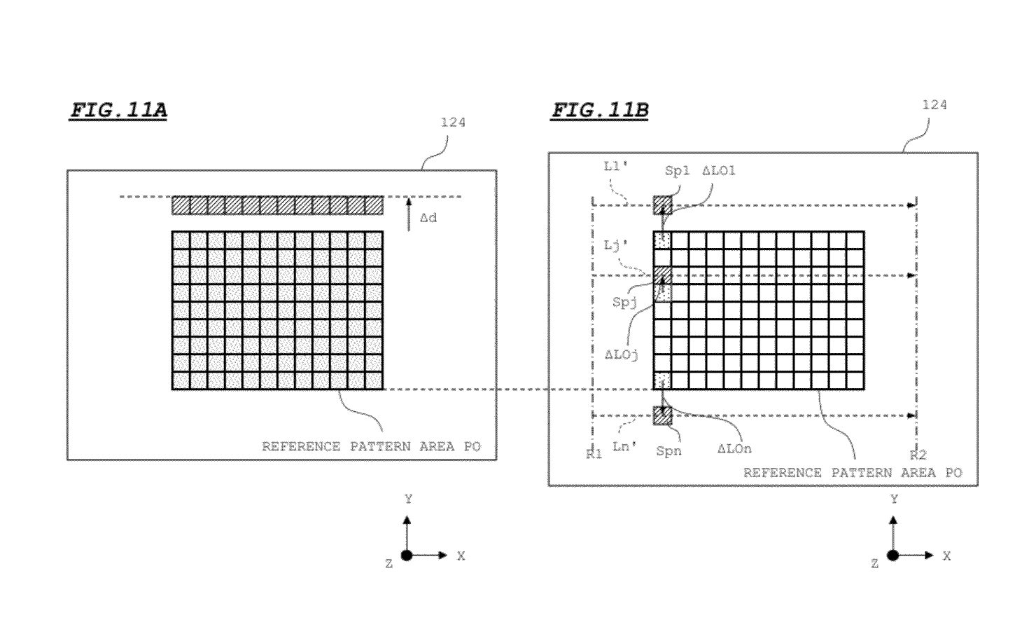

FIGS. 11A and 11B are diagrams showing an offset processing example.

FIG. 11A shows a case that the positions of the reference segment areas Sr1 through Srn searched in S201 in FIG. 10B are displaced from the reference position in plus Y-axis direction by the average displacement amount Δd. In this case, in S204 shown in FIG. 10B, a searching line at each row in the reference pattern area P0 is offset in accordance with the offset pattern corresponding to the average displacement amount Δd.

For instance, as shown in FIG. 11B, a segment area at the uppermost low is searched along a searching line L1′ which is offset from the position of the uppermost row in plus Y-axis direction by an offset amount ΔLO1. Further, a segment area Spj at j-th row from the uppermost row is searched along a searching line Lj′ which is offset from the position of j-th row in plus Y-axis direction by an offset amount ΔLOj. The offset amount ΔLOj is smaller than the offset amount ΔLO1. Further, a segment area Spn at a lowermost row is searched along a searching line Ln′ which is offset from the position of the lowermost row in plus Y-axis direction by an offset amount ΔLOn. The offset amount ΔLOn is substantially the same as the offset amount ΔLO1.

In this way, the searching lines at all the rows are offset, and a searching operation for each row is performed along the searching lines L′1 through L′n after the offset operation. By performing the above operation, even in the case where a segment area is displaced in Y-axis direction resulting from a wavelength variation, it is possible to smoothly perform a dot pattern matching operation for each segment area in the reference pattern area P0.

As described above, according to the embodiment, a searching line for each segment area is offset, based on a displacement amount of a reference segment area in Y-axis direction at the time of actual measurement. Accordingly, even if the dot pattern of laser light changes resulting from a wavelength variation of laser light, it is possible to accurately perform a segment area searching operation. Thus, it is possible to accurately detect a distance to an object to be detected.

Further, in this embodiment, since it is only necessary to extract and set an offset pattern in accordance with displacement amounts of the reference segment areas Sr1 through Srn in Y-axis direction, it is possible to reduce a processing amount for use in eliminating a wavelength variation of laser light.

Furthermore, in this embodiment, it is possible to precisely measure a distance to an object to be detected by updating an offset pattern depending on a wavelength variation, as necessary, without controlling the wavelength to a fixed value by a temperature control element such as a Peltier element. This is advantageous in suppressing the cost of the object detecting device and miniaturizing the object detecting device.

The embodiment of the invention has been described as above. The invention is not limited to the foregoing embodiment, and the embodiment of the invention may be changed or modified in various ways other than the above.

For instance, in this embodiment, in the case where a wavelength variation has occurred, a searching line for a segment area at each row in the reference template is offset without modifying the reference template TP. Alternatively, the reference template TP may be modified depending on a change in the wavelength.

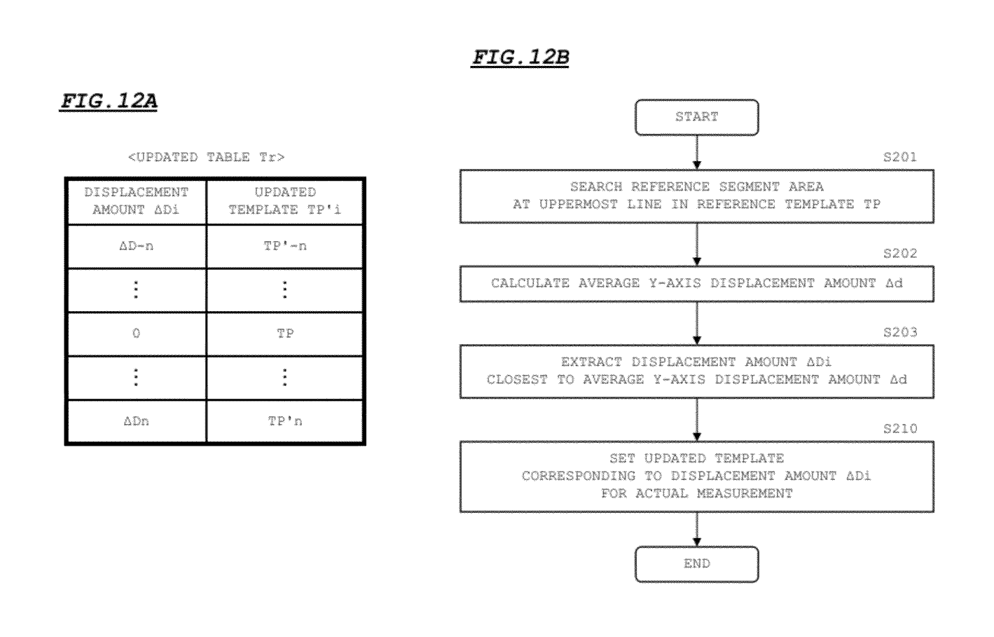

For instance, as shown in FIG. 12A, it is possible to store, into the memory 25, an updated table Tr in which a displacement amount ΔDi of a reference segment area and an updated template TP′i are correlated to each other, and to switch the template to be used at the time of actual operation from the reference template TP to the updated template TP′i, using the updated table Tr. In the modification, the updated template TP′i is configured in such a manner that a segment area at each row in the reference template TP is shifted upwardly or downwardly (plus Y-axis direction or minus Y-axis direction) in accordance with the displacement amount ΔDi.

FIG. 12B is a flowchart showing a template updating processing in the modification. The processing is performed in S103 shown in FIG. 9A.

S201 through S203 in FIG. 12B are the same as S201 through S203 shown in FIG. 9B. In S210, the updated template TP′i corresponding to the displacement amount ΔDi extracted in S203 is set as a template to be used at the time of actual measurement.

In the modification, in the case where the updated template TP′i is set as a template to be used at the time of actual measurement in S210 in FIG. 12B, a segment area searching operation at each row is performed by setting a line corresponding to each row in the updated template TP′i as a searching line. By performing the above operation, the searching line at each row is displaced from a position (reference position) to be used in the case where the reference template TP is used.

In the modification, it is possible to accurately perform a segment area searching operation, even if the dot pattern of laser light changes resulting from a wavelength variation of laser light, as well as in the embodiment. Thus, it is possible to accurately detect a distance to an object to be detected.

Further, in the embodiment, an offset pattern is stored in advance in correlation to a displacement amount ΔDi. Alternatively, an offset amount of a segment area at each row in the reference template may be obtained by computation based on a displacement amount of a reference segment area.

Further, in the embodiment, measurement of an Y-axis displacement amount from the reference pattern area P0 is performed only for a segment area at the uppermost line. Alternatively, an Y-axis displacement amount may also be measured for the lowermost line and for the middle line, as well as for the uppermost line. By performing the above operation, it is possible to enhance the detection precision on the Y-axis displacement amount. As far as the number of segment areas is one or more, measurement of an Y-axis displacement amount can be performed. For instance, an Y-axis displacement amount may be measured only for a leftmost segment area and for a rightmost segment area at the uppermost row.

Further, in the embodiment, there is prepared only one reference template TP. Alternatively, plural types of reference templates TP may be prepared for different wavelengths. In the modification, in the case where a searching error in the reference segment areas Sr1 through Srn has exceeded a threshold, as a result of a searching operation for the reference segment areas Sr1 through Srn in the searching area MA (see FIG. 10B) in a predetermined reference template TP, the reference segment areas Sr1 through Srn may be searched by using other reference template TP, and the reference template TP with use of which a searching error becomes equal to lower than the threshold may be used at the time of actual measurement.

Further, in the embodiment, segment areas adjacent to each other are set without overlapping each other. Alternatively, a certain segment area, and segment areas adjacent to the certain segment area vertically and horizontally may have a portion overlapping each other.

Further alternatively, the shape of the reference pattern area may be a square shape or other shape, in addition to the rectangular shape as described in the embodiment. Further alternatively, the shape of the updated pattern area may be modified, as necessary.

In the embodiment, the CMOS image sensor 124 is used as a light receiving element. Alternatively, a CCD image sensor may be used.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a light source which emits light of a predetermined wavelength band;
a diffractive optical element which irradiates the light onto the target area with a predetermined dot pattern;
a light receiving element which receives reflected light reflected on the target area for outputting a signal;
a storage which stores a reference template in which a plurality of segment areas is set in a reference pattern of the light received by the light receiving element;
an information acquiring section which searches a corresponding area corresponding to the segment area from an actual measurement pattern of the light received by the light receiving element for acquiring three-dimensional information of an object in the target area, based on a position of the searched corresponding area; and
a spreading detecting section which detects a change in a degree of spreading of a light receiving area of the actual measurement pattern with respect to a setting area of the reference pattern, wherein
the information acquiring section performs a searching operation of the corresponding area with respect to the actual measurement pattern along a searching line in parallel to an alignment direction in which the light source and the light receiving element are aligned, and displaces the searching line with respect to each segment area in a direction perpendicular to the alignment direction, from a reference position to be used when there is no change in the degree of spreading to be detected by the spreading detecting section, in accordance with the change in the degree of spreading.

2. The information acquiring device according to claim 1, wherein
the information acquiring section is operable to:
displace the searching line for use in searching the each segment area, from the reference position with respect to the each segment area, in such a direction that the searching line is located farther from a center of the setting area in the direction perpendicular to the alignment direction, in the case where the light receiving area of the actual measurement pattern spreads larger than a light receiving area of the reference pattern; and
displace the searching line for use in searching the each segment area, from the reference position with respect to the each segment area, in such a direction that the searching line is located closer to the center of the setting area in the direction perpendicular to the alignment direction, in the case where the light receiving area of the actual measurement pattern spreads smaller than the light receiving area of the reference pattern.

3. The information acquiring device according to claim 2, wherein
the information acquiring section sets a displacement amount of the searching line with respect to the reference position larger in the case where the segment area is located farther from the center of the setting area than in the case where the segment area is located closer to the center of the setting area.

4. The information acquiring device according to claim 1, wherein
the spreading detecting section searches a position of the segment area in the actual measurement pattern, the segment area being located farthest from the center of the setting area in the direction perpendicular to the alignment direction, for detecting the change in the degree of spreading of the light receiving area of the actual measurement pattern with respect to the setting area of the reference pattern, based on a result of the searching.

5. The information acquiring device according to claim 1, wherein
the information acquiring section holds a table in which an offset pattern for each searching line is correlated to a magnitude of the change in the degree of spreading, for offsetting the each searching line from the corresponding reference position at a time of actual measurement, based on the offset pattern corresponding to the magnitude of the change detected by the spreading detecting section.

6. An object detecting device, comprising:
an information acquiring device which acquires information on a target area using light,
the information acquiring device including:
a light source which emits light of a predetermined wavelength band;
a diffractive optical element which irradiates the light onto the target area with a predetermined dot pattern;
a light receiving element which receives reflected light reflected on the target area for outputting a signal;
a storage which stores a reference template in which a plurality of segment areas is set in a reference pattern of the light received by the light receiving element;
an information acquiring section which searches a corresponding area corresponding to the segment area from an actual measurement pattern of the light received by the light receiving element for acquiring three-dimensional information of an object in the target area, based on a position of the searched corresponding area; and
a spreading detecting section which detects a change in a degree of spreading of a light receiving area of the actual measurement pattern with respect to a setting area of the reference pattern, wherein
the information acquiring section performs a searching operation of the corresponding area with respect to the actual measurement pattern along a searching line in parallel to an alignment direction in which the light source and the light receiving element are aligned, and displaces the searching line with respect to each segment area in a direction perpendicular to the alignment direction, from a reference position to be used when there is no change in the degree of spreading to be detected by the spreading detecting section, in accordance with the change in the degree of spreading.

7. The object detecting device according to claim 6, wherein
the information acquiring section is operable to:
displace the searching line for use in searching the each segment area, from the reference position with respect to the each segment area, in such a direction that the searching line is located farther from a center of the setting area in the direction perpendicular to the alignment direction, in the case where the light receiving area of the actual measurement pattern spreads larger than a light receiving area of the reference pattern; and
displace the searching line for use in searching the each segment area, from the reference position with respect to the each segment area, in such a direction that the searching line is located closer to the center of the setting area in the direction perpendicular to the alignment direction, in the case where the light receiving area of the actual measurement pattern spreads smaller than the light receiving area of the reference pattern.

8. The object detecting device according to claim 7, wherein
the information acquiring section sets a displacement amount of the searching line with respect to the reference position larger in the case where the segment area is located farther from the center of the setting area than in the case where the segment area is located closer to the center of the setting area.

9. The object detecting device according to claim 6, wherein
the spreading detecting section searches a position of the segment area in the actual measurement pattern, the segment area being located farthest from the center of the setting area in the direction perpendicular to the alignment direction, for detecting the change in the degree of spreading of the light receiving area of the actual measurement pattern with respect to the setting area of the reference pattern, based on a result of the searching.

10. The object detecting device according to claim 6, wherein
the information acquiring section holds a table in which an offset pattern for each searching line is correlated to a magnitude of the change in the degree of spreading, for offsetting the each searching line from the corresponding reference position at a time of actual measurement, based on the offset pattern corresponding to the magnitude of the change detected by the spreading detecting section.
